(19) United States
(12) Patent Application Publication
(10) Pub. No.: US 2023/0316146 A1
(43) Pub. Date: Oct. 5, 2023

(54) DATA PROCESSING METHOD AND APPARATUS FOR TRAINING DEPTH INFORMATION ESTIMATION MODEL

(71) Applicant: 42DOT INC., Seoul (KR)

(72) Inventors: Seung Hun CHO, Seoul (KR); Dong Jin Ha, Seoul (KR); Ho Yeon Cho, Suwon (KR); Jung Hee Kim, Seoul (KR); Phuoc Tien Nguyen, Suwon (KR); Seong Gyun Jeong, Yongin (KR)

(21) Appl. No.: 18/191,027

(22) Filed: Mar. 28, 2023

(30) Foreign Application Priority Data
Mar. 29, 2022 (KR) 10-2022-0038596

(51) Int. Cl. G06N 20/00

(52) U.S. Cl. CPC G06N 20/00

(57) ABSTRACT

Provided are a data processing method and apparatus for training a depth information estimation model. The data processing method for training a depth information estimation model, includes: logging image data collected from one or more cameras; transmitting the logged image data to a database; configuring training data, based on the image data of the database; and training a model, based on the training data.

### CROSS-REFERENCE TO RELATED APPLICATION

This application claims the benefit of Korean Patent Application No. 10-2022-0038596, filed on Mar. 29, 2022, in the Korean Intellectual Property Office, the disclosure of which is incorporated herein in its entirety by reference.

### BACKGROUND

### 1. Field

The present disclosure relates to a data processing method and apparatus for training a depth information estimation model.

### 2. Description of the Related Art

Methods of estimating 3-dimensional (3D) depth information used in various fields, such as robot vision, human computer interface, intelligent visual surveillance, and 3D image acquisition, are being actively studied. In particular, for an autonomous driving system, studies on highly accurate depth information estimation are required to control a vehicle by recognizing and determining various driving environments, as well as a distance between the vehicle and an object detected from collected image data.

To improve functions of an artificial intelligence model, including depth information estimation, performance of an artificial neural network of the artificial intelligence model is important, but so is data for training and evaluating the artificial intelligence model. As the amount of training data or evaluating data increases, the performance of the artificial intelligence model also tends to increase, but the amount and the performance are not always proportional. There may be a case where inappropriate data is learned and rather, there may be an issue of overfitting. Accordingly, it is also important to enhance quality of the training data or evaluating data by suitably processing the training data or evaluating data for training the artificial intelligence model.

The aforementioned background technology is technical information possessed by the inventor for derivation of the present disclosure or acquired by the inventor during the derivation of the present disclosure, and is not necessarily prior art disclosed to the public before the application of the present disclosure.

### SUMMARY

Provided are a data processing method and apparatus for training a depth information estimation model. Aspects of the present disclosure are not limited to those mentioned above, and other aspects and advantages of the present disclosure, which are not mentioned, will be understood from descriptions below and will become more apparent by embodiments of the present disclosure. In addition, the aspects and advantages of the present disclosure will be realized through means and combinations thereof in the claims.

According to an aspect of an embodiment, a data processing method for training a depth information estimation model, includes: logging image data collected from one or more cameras; transmitting the logged image data to a database; configuring training data, based on the image data of the database; and training a model, based on the training data.

According to an aspect of another embodiment, a data processing apparatus for training a depth information estimation model, includes: a memory storing at least one program; and a processor configured to execute the at least one program to: log image data collected from one or more cameras; transmit the logged image data to a database; configure training data, based on the image data of the database; and train a model, based on the training data.

According to an aspect of another embodiment, a computer-readable recording medium has recorded thereon a program for executing the data processing method above on a computer.

In addition, provided are other methods and apparatuses for implementing the present disclosure, and computer-readable recording media having recorded thereon programs for executing the other methods.

Other aspects, features, and advantages may become clear from the following drawings, the claims, and the detailed description of the present disclosure.

### BRIEF DESCRIPTION OF THE DRAWINGS

These and/or other aspects will become apparent and more readily appreciated from the following description of the embodiments, taken in conjunction with the accompanying drawings in which:

FIGS. 1 through 3 are diagrams for describing an autonomous driving method, according to an embodiment;

FIG. 4 is a diagram for describing examples of a plurality of objects included in image data, according to an embodiment;

FIG. 5 is a diagram briefly showing a general aspect of a work flow of a data processing apparatus, according to an embodiment;

FIGS. 6A through 6C are diagrams for describing a process of logging image data collected from one or more cameras, according to an embodiment;

FIGS. 7A and 7B are diagrams for describing a rectification process according to an embodiment;

FIG. 8 is a flowchart of a rectification matrix suitability determination process according to an embodiment;

FIG. 9 is a diagram for describing a clustering process for data, according to an embodiment;

FIG. 10 is a diagram for briefly describing a training or evaluating process of an artificial intelligence model, according to an embodiment;

FIG. 11 is a flowchart of a data processing method for training a depth information estimation model, according to an embodiment; and

FIG. 12 is a block diagram of a data processing apparatus for training a depth information estimation model, according to an embodiment.

### DETAILED DESCRIPTION

Advantages and features of the present disclosure and methods of accomplishing the same may be understood more readily by reference to the following detailed description of the embodiments and the accompanying drawings. However, it should be understood that the present disclosure is not limited to the embodiments presented below, but may be implemented in various different forms, and include all transformations, equivalents, and substitutes included in the scope of the present disclosure. The embodiments presented below are provided to complete the present disclosure and to fully inform one of ordinary skill in the art of the scope of the present disclosure. In the description of the present disclosure, certain detailed explanations of related art are omitted when it is deemed that they may unnecessarily obscure the essence of the present disclosure.

Also, the terms used in the present specification are only used to describe specific embodiments, and are not intended to limit the present disclosure. An expression used in the singular encompasses the expression in the plural, unless it has a clearly different meaning in the context. In the present specification, it is to be understood that terms such as “including” or “having”, etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

Some embodiments of the present disclosure may be represented by functional block configurations and various processing operations. Some or all of these functional blocks may be implemented by various numbers of hardware and/or software configurations that perform particular functions. For example, the functional blocks of the present disclosure may be implemented by one or more microprocessors or by circuit configurations for a certain function. Also, for example, the functional blocks of the present disclosure may be implemented in various programming or scripting languages. The functional blocks may be implemented by algorithms executed in one or more processors. In addition, the present disclosure may employ general techniques for electronic environment setting, signal processing, and/or data processing. Terms such as “mechanism”, “element”, “means”, and “configuration” may be used widely and are not limited as mechanical and physical configurations.

In addition, a connection line or a connection member between components shown in drawings is merely a functional connection and/or a physical or circuit connection. In an actual device, connections between components may be represented by various functional connections, physical connections, or circuit connections that are replaceable or added.

Hereinafter, a “vehicle” may denote any type of transportation means including an engine and used to move a person or an object, such as a car, a bus, a motorcycle, a scooter, or a truck.

Hereinafter, the present disclosure will be described in detail with reference to accompanying drawings.

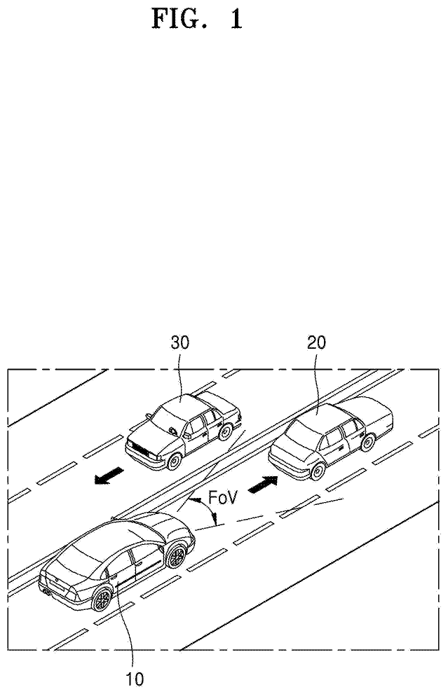

Referring to FIG. 1, an autonomous driving apparatus according to an embodiment of the present disclosure may realize an autonomous driving vehicle 10 by being mounted on a vehicle. The autonomous driving apparatus mounted on the autonomous driving vehicle 10 may include various sensors (including a camera) for collecting situation information around the autonomous driving vehicle 10. For example, the autonomous driving apparatus may detect movement of a preceding vehicle 20 in front, through an image sensor and/or an event sensor provided at the front of the autonomous driving vehicle 10. The autonomous driving apparatus may further include sensors for detecting not only the front of the autonomous driving vehicle 10, but also another driving vehicle 30 at a side lane, and a pedestrian and the like around the autonomous driving vehicle 10.

At least one of sensors for collecting the situation information around the autonomous driving vehicle 10 may have a certain field of view (FoV) as shown in FIG. 1. For example, when a sensor mounted at the front of the autonomous driving vehicle 10 has the FoV shown in FIG. 1, information detected at the center of the sensor may have relatively high importance. This is because the information detected at the center of the sensor includes most pieces of information corresponding to the movement of the preceding vehicle 20.

The autonomous driving apparatus may control movement of the autonomous driving vehicle 10 by processing, in real time, pieces of information collected by the sensors of the autonomous driving vehicle 10, while storing at least some of the pieces of information collected by the sensors in a memory device.

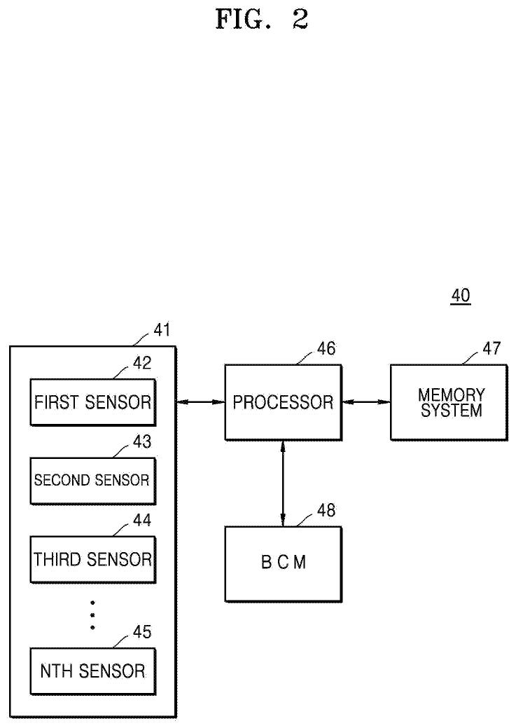

Referring to FIG. 2, an autonomous driving apparatus 40 may include a sensor unit 41, a processor 46, a memory system 47, and a body control module (BCM) 48. The sensor unit 41 includes a plurality of sensors (including a camera), i.e., first through Nth sensors 42 through 45, and the first through Nth sensors 42 through 45 may include an image sensor, an event sensor, an illumination sensor, a global positioning system (GPS) device, and an acceleration sensor.

Pieces of data collected by the first through Nth sensors 42 through 45 may be transmitted to the processor 46. The processor 46 may store the pieces of data collected by the first through Nth sensors 42 through 45 in the memory system 47, and determine movement of a vehicle by controlling the BCM 48, based on the pieces of data collected by the first through Nth sensors 42 through 45. The memory system 47 may include two or more memory devices and a system controller for controlling the two or more memory devices. Each of the memory devices may be provided as one semiconductor chip.

In addition to the system controller of the memory system 47, each of the memory devices included in the memory system 47 may include a memory controller, and the memory controller may include an artificial intelligence (AI) arithmetic circuit, such as a neural network. The memory controller may generate arithmetic data by assigning a certain weight to data received from the first through Nth sensors 42 through 45 or the processor 46, and store the arithmetic data in a memory chip.

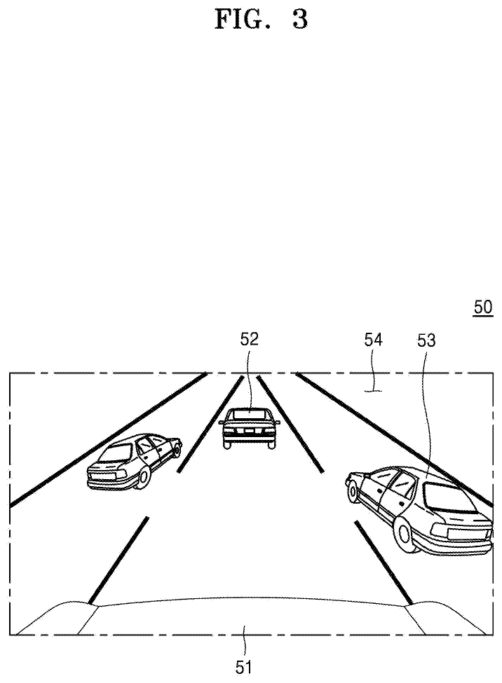

FIG. 3 is a diagram showing an example of image data obtained by sensors (including a camera) of an autonomous driving vehicle on which an autonomous driving apparatus is mounted. Referring to FIG. 3, the image data 50 may be data obtained by a sensor mounted at the front of the autonomous driving vehicle. Accordingly, the image data 50 may include a front portion 51 of the autonomous driving vehicle, a preceding vehicle 52 on a same lane as the autonomous driving vehicle, and a driving vehicle 53 and background 54 around the autonomous driving vehicle.

In the image data 50 according to an embodiment shown in FIG. 3, data of regions indicating the front portion 51 of the autonomous driving vehicle and the background 54 may be data that is least likely to affect driving of the autonomous driving vehicle. In other words, the front portion 51 of the autonomous driving vehicle and the background 54 may be considered as data having relatively low importance.

On the other hand, a distance from the preceding vehicle 52 and lane change movement of the driving vehicle 53 may be very important factors in safe driving of the autonomous driving vehicle. Accordingly, data of regions including the preceding vehicle 52 and driving vehicle 53 in the image data 50 may have relatively high importance in driving of the autonomous driving vehicle.

A memory device of the autonomous driving apparatus may assign different weights to regions of the image data 50 received from the sensors and store the same. For example, a high weight may be assigned to the data of the regions including the preceding vehicle 52 and the driving vehicle 53, and a low weight may be assigned to the data of the regions including the front portion 51 of the autonomous driving vehicle and the background 54.

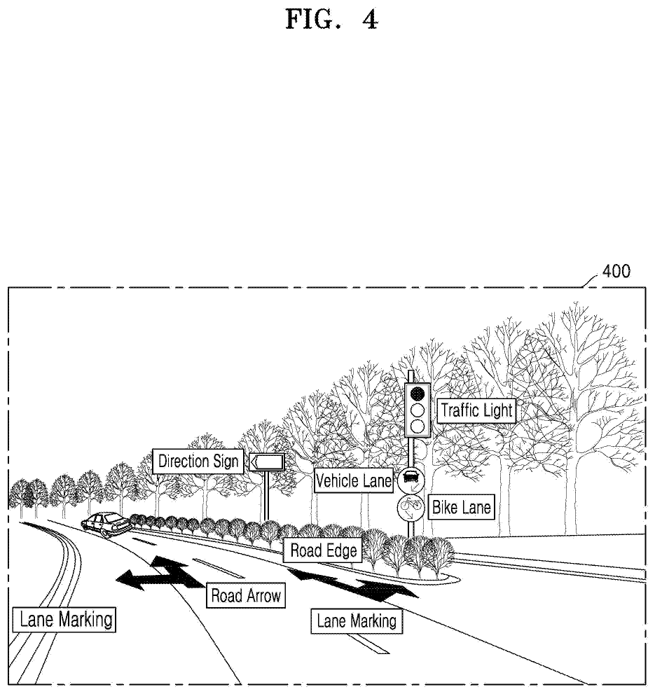

FIG. 4 is a diagram for describing examples of a plurality of objects included in image data, according to an embodiment.

The image data 400 collected through one or more cameras may be used to train a deep neural network model for depth information estimation. The collected image data 400 may include the plurality of objects.

Information about an object includes object type information and object attribute information. Here, the object type information is index information indicating a type of the object, and includes a group that is a large range and a class that is a detail range. Also, the object attribute information is attribute information about a current state of the object, and includes movement information, rotation information, traffic information, color information, and visibility information.

According to an embodiment, the group and class included in the object type information may be as Table 1 below, but are not limited thereto.

TABLE 1

| Group | Class |
|---|---|
| Flat | Road, Sidewalk, Parking, Ground, Crosswalk |
| Human | Pedestrian, Rider |
| Vehicle | Car, Truck, Bus, Bike, Mobility |
| Construction | Building, Wall, Guard rail, Tunnel, Fence, |
| | Soundproof wall, Gas Station, IC, pylon |
| Object | Pole, Traffic sign, Traffic light, Color cone |
| Nature | Vegetation, Terrain, Paddy filed, Field, River, Lake |
| Void | Static |
| Lane | Dotted line, Solid line, Dotted and Solid |
| | line, Double Solid line |
| Sky | Sky |
| Animal | Dog, cat, Bird, etc |

Also, information included in the object attribute information may include Action, Rotate, Traffic info, color, and Visibility.

Action represents the movement information of the object, and may be defined as stopping, parking, and moving. In case of a vehicle, stopping, parking, and moving may be determined as the object attribute information, and in case of an immobile object, such as a traffic light, stopping that is a default value may be determined as the object attribute information.

Rotate represents the rotation information of the object, and may be defined as front, back, horizontal, vertical, or side. In case of a vehicle, front, back, and side may be determined as the object attribute information, and in case of a horizontal or vertical traffic light, horizontal or vertical may be determined as the object attribute information.

Traffic info may denote the traffic information of the object, and may be defined as direction, warning, regulatory, and supplementary signs of traffic signs. Color may denote the color information of the object, and may represent a color of an object, a color of a traffic light, or a color of a traffic sign.

Referring to FIG. 4, the objects included in the collected image data 400 may include a traffic light, a direction sign, a current driving lane, a load marking, a crosswalk, a speed bump, and a crossroad, but are not limited thereto.

Hereinafter, “image data” may denote a set of consecutive pieces of image data collectable by a camera, and “image data in each detail process performed by an apparatus or in each detail operation of a method may be used in a concept including single piece of image data, a single image data set, or consecutive pieces of image data.

Hereinafter, a data processing operation according to various embodiments may be understood as being performed by a data processing apparatus or a processor included in the data processing apparatus.

The data processing apparatus or an autonomous driving apparatus realizing an autonomous driving vehicle may include an AI model. In the present disclosure, the AI model may be trained by using image data collected through one or more cameras, and may perform depth information estimation on the collected image data. In the present disclosure, the AI model includes a model commonly used for machine learning or a model commonly used for deep learning.

According to an embodiment, the AI model of the present disclosure may include an artificial neural network.

The artificial neural network may denote any model having a problem-solving ability and including artificial nodes (neurons) forming a network through a combination of synapses. The artificial neural network may be defined by a connection pattern between nodes of different layers, a learning process of updating a model parameter, and an activation function of generating an output.

The artificial neural network may include a plurality of layers. Each layer may include one or more nodes, and the artificial neural network may include a synapse connecting the nodes. In the artificial neural network, each node may output a function value of the activation function regarding input signals input through a synapse, a weight, and a deflection.

A model parameter denotes a parameter determined through training, and may include a weight of a synapse connection and a deflection of a node. A hyper parameter denotes a parameter to be set through a machine learning algorithm before training, and may include a learning rate, the number of repetitions, a size of a mini batch, and an initialization function.

A purpose of training of the artificial neural network is to determine the model parameter that minimizes a loss function. The loss function may be used as an index for determining an optimum model parameter during a training process of the artificial neural network. The artificial neural network may be trained through a forward propagation process and a back propagation process.

In the present disclosure, the AI model of the autonomous driving apparatus or data processing apparatus may convert the collected image data into a high-level feature by using several machine learning algorithms and technologies, and generate a depth map from the high-level feature. The depth map is a video or image containing information about a distance from an observation viewpoint to an object surface. The depth map may have a same size as the image data and may indicate depth information of a pixel level. The AI model for estimating the depth information outputs the depth map, based on the input image data, and may be trained through an automated system by using the depth map.

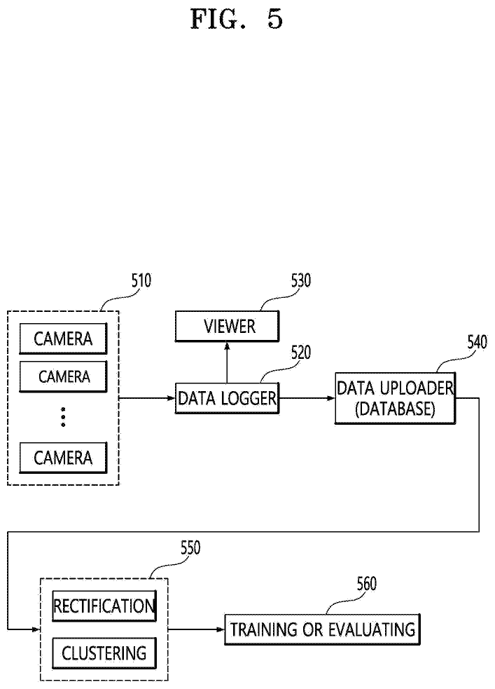

FIG. 5 is a diagram briefly showing a general aspect of a work flow of a data processing apparatus, according to an embodiment.

In the present disclosure, one or more cameras 510 may collect image data. The image data collected by the one or more cameras 510 may be logged by a data logger 520. Data logged by the data logger 520 may be transmitted to a viewer 530 to be displayed to a user or a manager. A viewer interface may be configured in the viewer 530 to display the data to the user or the manager. The logged data may be transmitted to and stored in a database by a data uploader 540. A data configurator 550 may configure training data or evaluating data, based on the image data of the database. During a process of configuring the training data or evaluating data, a rectification or clustering process may be performed. The configured data may be transmitted for training or evaluating 560 to be used as the training data or evaluating data, and the training data may be used to train an AI model and the evaluating data may be used to evaluate the trained AI model.

Hereinafter, specific and various embodiments related to each data processing procedure of the present disclosure will be described in more detail.

According to an embodiment, image data may be collected through one or more cameras.

There may be various types of cameras for collecting the image data. According to an embodiment, each camera may be a monocular camera. According to an embodiment, one or more cameras may have a stereo structure.

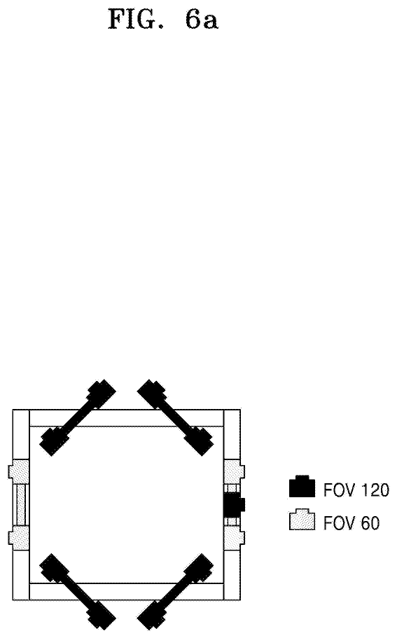

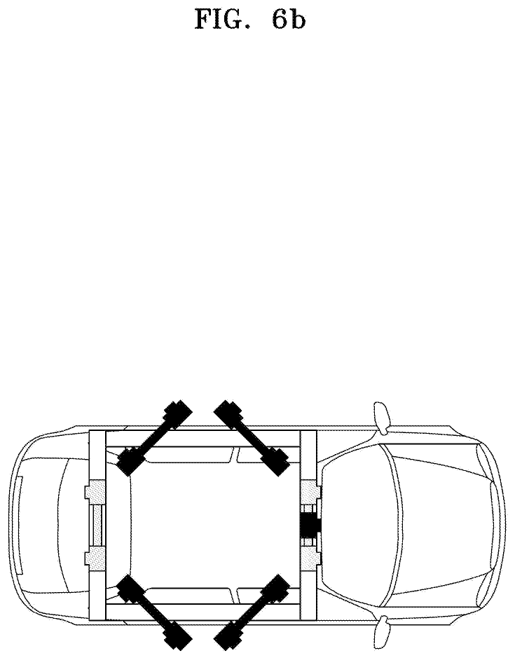

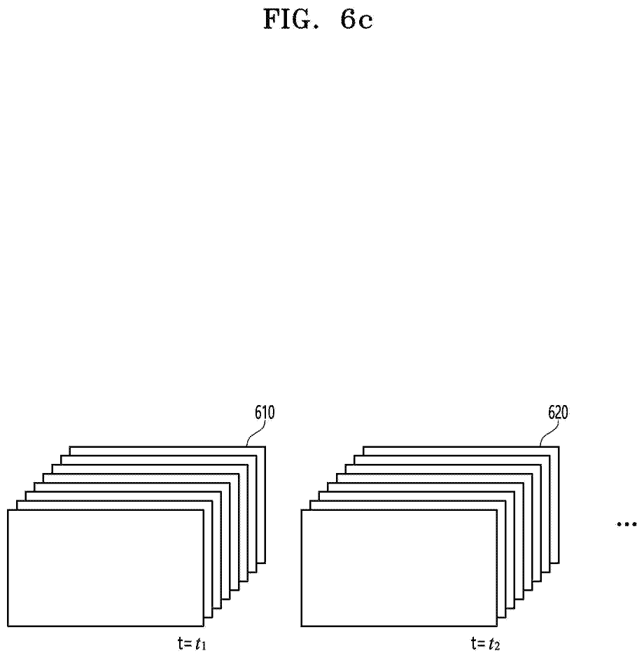

FIGS. 6A through 6C are diagrams for describing a process of logging image data collected from one or more cameras, according to an embodiment.

FIG. 6A illustrates an image data acquiring structure of a multi-camera structure, according to an embodiment.

As illustrated, the image data acquiring structure of the multi-camera structure, according to an embodiment may include one or more cameras. The one or more cameras in the image data acquiring structure of the multi-camera structure may be arranged to acquire image data of all directions of a vehicle. The multi-camera structure may include a stereo structure camera pair, in which two or more cameras arranged in a same direction form a pair, to obtain an image.

As illustrated, the image data acquiring structure of the multi-camera structure may include a camera of a 60° F.oV and a camera of a 120° F.oV. As illustrated, the stereo structure camera pairs including two cameras of a same FoV are arranged to acquire the image data of all directions, and an additional camera arranged in a driving direction of the vehicle is arranged. However, the above descriptions are only an example and do not limit the present disclosure. The FoV, number, orientation, and arrangement of cameras in the image data acquiring structure of the multi-camera structure may vary.

According to an embodiment, a camera may acquire an image in a jpeg format having resolution of 1920×1080, in units of 15 fps.

FIG. 6B illustrates the image data acquiring structure of the multi-camera structure of FIG. 6A being mounted on the vehicle, according to an embodiment. Through such a structure, data may be easily collected in various driving situations while the vehicle is being driven.

The image data collected from the one or more cameras may be logged through a data logger. The data logger that may be included in a data processing apparatus may efficiently manage the image data that may be a basis of data used to train or evaluate an AI model.

FIG. 6C illustrates images having a same timestamp being paired up, according to an embodiment.

Image data collected from one camera may be considered as a set of a plurality of consecutive images. In other words, the image data collected from one camera may include a plurality of images. According to an embodiment, the plurality of images included in the image data may each include a timestamp. The timestamp may indicate time information each image is collected by the camera.

Accordingly, for example, when the image data acquiring structure of the multi-camera structure of the autonomous driving vehicle includes eight cameras (for example, two front-oriented cameras, four side-oriented cameras, and two back-oriented cameras), there may be eight images having a same timestamp. The data logger may store synchronized images by pairing up the images having the same timestamp.

Referring to FIG. 6C, a paired image set 610 and a paired image set 620 are illustrated. The image set 610 is an image set in which images having a same timestamp t₁ are paired up. The image set 620 is an image set in which images having a same timestamp t₂ are paired up. For example, t₁ and t₂ may be adjacent timestamps. The image set 610 and the image set 620 may each include eight images collected from different cameras. The data logger may pair up the images having the same timestamp to configure the image set 610 and the image set 620, which are synchronized images, and store the same.

According to an embodiment, the data logger may combine the collected image data with inertia information measured by an inertial measurement unit (IMU) and store the same.

In the present disclosure, the IMU may denote a device mounted on the autonomous driving vehicle (or the image data acquiring structure of the multi-camera structure mounted on the autonomous driving vehicle) and capable of outputting information about a speed of the autonomous driving vehicle, a rotating speed, force applied to the autonomous driving vehicle, and a position of the autonomous driving vehicle. The IMU may include a gyroscope and an accelerometer, and may include a geomagnetic sensor.

Because the data logger combines the collected image data with the inertia information measured by the IMU and stores the same, even information related to a surrounding environment of the autonomous driving vehicle, for example, a case where a road is sloped or a case where a road is not even, may be included in training data or evaluating data.

According to an embodiment, the synchronized images stored by the data logger may be used to be displayed to the user or the manager. According to an embodiment, the synchronized images may be transmitted to a display device in units of images having a same timestamp. According to an embodiment, a viewer interface may be configured for easy observation by the user or the manager. For example, the viewer interface may be configured such that the images having the same timestamp are displayed together.

According to an embodiment, the viewer interface may include an interface for controlling the data logger. For example, the viewer interface may include an activation or deactivation control function for a logging operation of the data logger. For example, the viewer interface may display usage information of a storage device, such as the database.

According to an embodiment, the viewer interface may be configured to display the collected image data in real time. According to an embodiment, the viewer interface may include a capture function. According to an embodiment, the viewer interface may include a function of displaying only image data collected by a specific camera. According to an embodiment, the viewer interface may include a function of searching for image data collected during a specific time period.

According to an embodiment, the image data logged by the data logger may be transmitted to and stored in the database. According to an embodiment, the logged image data may be transmitted to the database in real time. According to an embodiment, the logged image data may be accumulated and stored in a temporary storage, and data triggered and accumulated by an input of the user or the manager may be transmitted to the database. According to an embodiment, the logged image data may be accumulated and stored in the temporary storage, and the accumulated data may be transmitted to the database when an amount of data stored in the temporary storage reaches certain capacity. According to an embodiment, the logged image data may be accumulated and stored in the temporary storage and the accumulated data may be transmitted to the database automatically when driving is ended. Data transmission to the database may be performed by an any appropriate transmission method.

In the present disclosure, the training data or evaluating data may be configured from the image data stored in the database. While the training data or evaluating data is being configured, the rectification or clustering process may be performed on the image data stored in the database to effectively train or evaluate the AI model.

According to an embodiment, the rectification process may be performed to configure the training data or evaluating data.

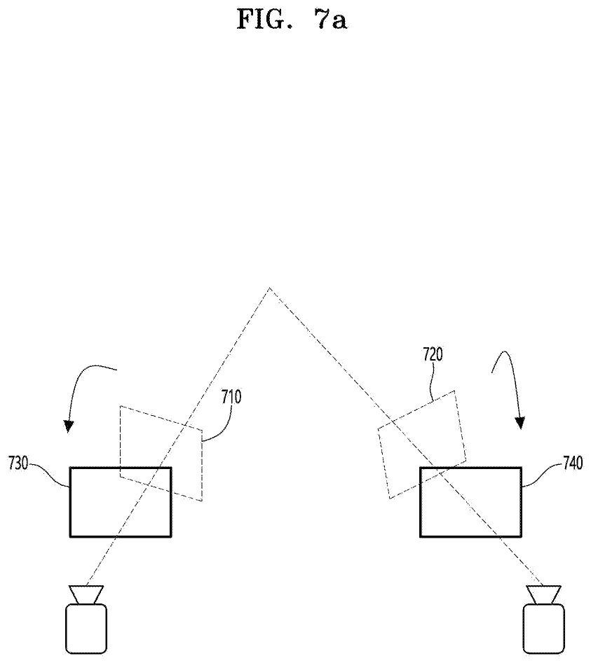

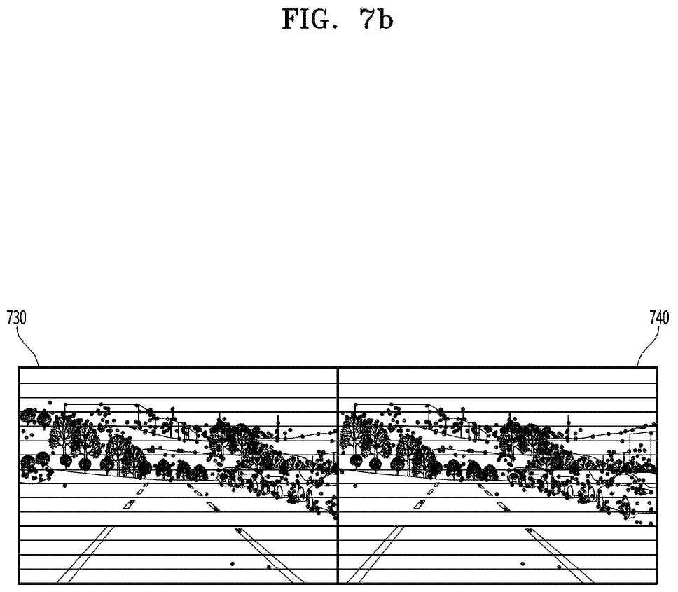

FIGS. 7A and 7B are diagrams for describing the rectification process according to an embodiment.

According to an embodiment, the training data or evaluating data may be generated through stereo matching-based depth information estimation. As described above, the image data acquiring structure of the multi-camera structure, according to an embodiment, may include one or more cameras, and the multi-camera structure may include a stereo structure camera pair, in which two or more cameras arranged in a same direction form a pair, to acquire an image. Images acquired by left and right cameras of the stereo structure camera pair may have disparity. Disparity of stereo image data may be calculated through a stereo camera calibration process and an image rectification process, and the training data or evaluating data may be generated by estimating depth information through such disparity.

In detail, the stereo image data may be aligned on a same row through the rectification process, and accordingly, disparity information of an object may be extracted. A stereo camera may have a tolerance during a production process, and an arrangement of the stereo camera may be misaligned while being used. In particular, when the stereo camera is mounted on the autonomous driving vehicle, image data collected by both cameras is easily misaligned due to an impact or the like caused by a road condition. Thus, it is substantially unable to collect the image data such that rows between the stereo cameras match each other, and the rectification process for matching the rows is required.

FIG. 7A is a schematic diagram for describing applying of a rectification matrix on image data collected by a stereo camera.

According to an embodiment, a data processing apparatus may acquire the rectification matrix by deriving an extrinsic parameter for a stereo camera pair through camera calibration. Referring to FIG. 7A, two cameras configure the stereo camera, and image data 710 collected by a left camera and image data 720 collected by a right camera are illustrated. For depth information estimation through an AI model, the rectification matrix is required to align the image data 710 collected by the left camera and the image data 720 collected by the right camera on a same row.

According to an embodiment, the data processing apparatus may obtain corrected image data as a result of applying the rectification matrix on image data. Referring to FIG. 7A, corrected left image data 730 and corrected right image data 740 may be obtained by applying the rectification matrix on the image data 710 collected by the left camera and the image data 720 collected by the right camera, respectively. The corrected left image data 730 and the corrected right image data 740 are used to extract depth information by calculating horizontal, i.e., x-axis, disparity through comparison.

As described above, image data may be corrected by applying a rectification matrix and depth information may be extracted by calculating horizontal disparity, based on the corrected image data, and this may be performed on the premise that vertical alignment of the corrected image data is correct. The rectification matrix may be changed by an external environment of a camera collecting image data, for example, pneumatic pressure of a tire or an external impact. Accordingly, it may be required to verify whether the rectification matrix has been appropriately acquired.

FIG. 7B is a schematic diagram for describing a process of verifying vertical disparity of corrected stereo image data.

According to an embodiment, after applying an acquired rectification matrix on stereo image data, a process of verifying vertical disparity of a result of applying the rectification matrix may be performed.

In detail, according to an embodiment, a numerical value of vertical disparity may be calculated for the stereo image data after the rectification matrix is applied. The numerical value of the vertical disparity may denote a value indicating a degree the stereo image data is misaligned in a vertical direction, i.e., a y-axis direction. In other words, the stereo image data is compared with data after the rectification matrix is applied to digitize a misaligned degree.

According to an embodiment, the numerical value of the vertical disparity may be calculated based on a feature point. According to an embodiment, the numerical value of the vertical disparity may be calculated to be an average value of all disparities. According to an embodiment, the numerical value of the vertical disparity may be indicated as a value of a case in which a difference between feature points where disparity occurs is the greatest. In addition, the numerical value of the vertical disparity may be a value calculated appropriately to represent or indicate the vertical disparity of the stereo image data. Referring to FIG. 7B, vertical disparity verification, in particular, feature point-based vertical disparity verification, may be performed on the corrected left image data 730 and the corrected right image data 740.

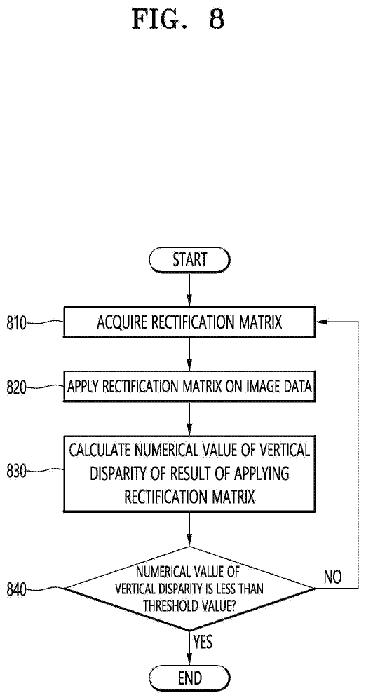

FIG. 8 is a flowchart of a rectification matrix suitability determination process according to an embodiment.

According to an embodiment, the rectification matrix suitability determination process of considering that a rectification matrix is suitable or unsuitable through comparison between a calculated numerical value of vertical disparity and a threshold value, and reacquiring the rectification matrix when the rectification matrix is unsuitable may be automated.

In detail, according to an embodiment, a data processing apparatus may obtain a rectification matrix (operation 810 and apply the rectification matrix on image data (operation 820). The data processing apparatus may calculate a numerical value of vertical disparity for corrected image data that is a result of applying the rectification matrix (operation 830).

The data processing apparatus may determine whether the calculated numerical value of vertical disparity is less than a threshold value (operation 840). When it is determined that the numerical value of the vertical disparity is less than the threshold value, the data processing apparatus may consider that the rectification matrix is suitable. When it is determined that the numerical value of the vertical disparity is not less than the threshold value, the data processing apparatus may consider that the rectification matrix is unsuitable.

When it is determined that the calculated numerical value of the vertical disparity is not less than the threshold value, the data processing apparatus may perform operation 810 of acquiring the rectification matrix again through camera calibration.

The threshold value may be assigned as a value determined that suitable depth information estimation is unable to be performed due to incorrect alignment of stereo image data when exceeded, according to a method of calculating the numerical value of vertical disparity.

When a camera is mounted on an autonomous driving vehicle, the autonomous driving vehicle and the camera mounted thereon are exposed to an external environment that variously changes, and thus a rectification matrix acquired in the past may be no longer suitable according to the changed external environment. In this regard, an unsuitable rectification matrix may be detected and a rectification matrix for the changed external environment may be reacquired to more suitably train or evaluate an AI model.

According to an embodiment, a clustering process may be performed to configure training data or evaluating data.

According to clustering, pieces of data included in a data set are divided into a plurality of clusters such that pieces of data having similar properties form a group. Through a process of dividing the pieces of into the plurality of clusters, the clustering classifies pieces of data belonging to a same cluster as being close or similar to each other and pieces of data belonging to different clusters as being far from or not similar to each other.

In the present disclosure, a data processing apparatus may perform clustering on collected pieces of image data such that pieces of data having similar features form a cluster. When an AI model is to be trained or evaluated with a same cost and a same amount of samples, it may be efficient to train or evaluate the AI model for various features or vulnerable features compared to training or evaluating the AI model by randomly sampling pieces of collected data. In the regard, the clustering efficiently configures the training data or evaluating data.

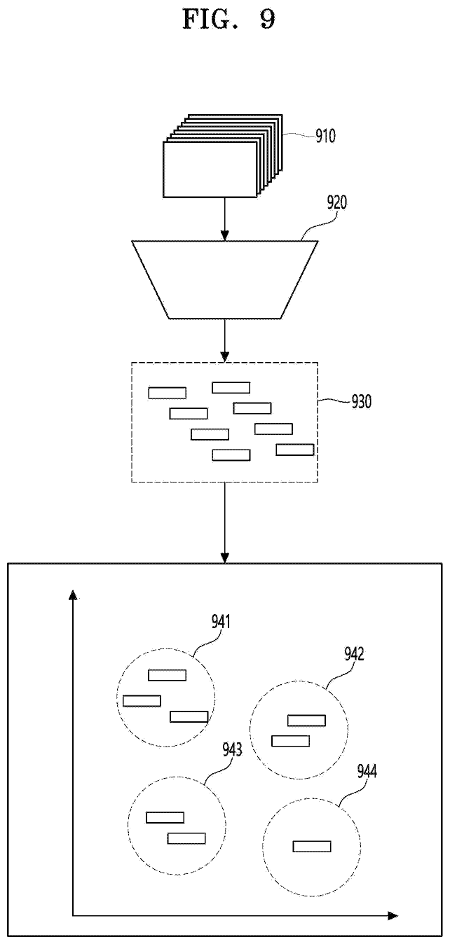

FIG. 9 is a diagram for describing a clustering process for data, according to an embodiment.

Referring to FIG. 9, a data processing apparatus may classify pieces of collected data 910 such that pieces of data having similar features form clusters 941 through 944 through the clustering process.

In detail, the pieces of collected data 910 are input to a feature vector extractor 920. Then, the feature vector extractor 920 extracts feature vectors 930 of the pieces of collected data 910 as outputs. Grouping is performed on the extracted feature vectors 930. A clustering result is illustrated at the bottom of FIG. 9, and here, the feature vectors 930 are clustered into four clusters 941 through 944, and the four clusters 941 through 944 are represented in a Euclid space. Each cluster has a centroid (not shown). Each feature vector may be understood as being clustered into a cluster having the closest centroid from among a plurality of centroids.

In the clustering result illustrated at the bottom of FIG. 9, for example, the cluster 941 may include a feature vector of data having a feature associated with a crosswalk, and the cluster 944 may include a feature vector of data having a feature associated with the first lane.

According to an embodiment, the feature vector extractor 920 may include a convolutional neural network. For example, the feature vector extractor 920 may have any appropriate convolutional neural network structure, such as ResNet, VGGNet, LeNet, AlexNet, ZFNet, or GoogleNet.

According to an embodiment, during the clustering process, any appropriate algorithm, such as a K-means algorithm or a modification thereof, or a hierarchical clustering algorithm, may be used.

According to an embodiment, based on processes described above, feature vectors may be extracted for image data of a database, and the extracted feature vectors may be clustered into one or more clusters. Training data or evaluating data may be sampled from the one or more clusters. Here, the training data or evaluating data may be evenly sampled from each cluster, and in some cases, may be intentionally unevenly sampled from each cluster.

According to an embodiment, the image data of the database may be clustered based on pre-collected data. In detail, the pre-collected data may refer to a relatively large amount of data that is pre-constructed, rather than data newly collected from one or more cameras. The data processing apparatus may extract advance feature vectors for pre-collected data, form base clusters based on the advance feature vectors, and extract centroids. The extracted centroids for the base clusters may be mapped to a coordinate plane (Euclid space). A suitable number of base clusters may be formed according to a purpose of an AI model. In general, a large number of base clusters may be formed such that the AI model may learn and perform a classification task regarding various situations and environments.

According to an embodiment, the data processing apparatus may perform clustering on newly collected data, based on the centroids of the base clusters. The data processing apparatus may extract a feature vector of the newly collected data, and map the extracted feature vector to a same coordinate plane as a coordinate plane to which the centroids of the base clusters are mapped. Then, the data processing apparatus may calculate a distance between the mapped feature vector and the centroids of the bae clusters, and cluster feature vectors that share the closest centroid.

Through such processes, a process of extracting a separate centroid for the newly collected data may be omitted. In addition, a vulnerable part may be pre-determined through a clustering analysis on the pre-collected data, and the vulnerable part may be reflected to configure the training data or evaluating data based on the newly collected data or to newly collect data to configure the training data or evaluating data. Also, when clusters are pre-formed based on a larger amount of pre-collected data than the newly collected data, the AI model may be able to learn various situations and environments by forming a larger number of base clusters.

According to an embodiment, a camera mounted on an autonomous driving vehicle may reinforce image data collection regarding the vulnerable part through the clustering analysis on the pre-collected data.

In the above-described embodiments, it has been described that a centroid and a feature vector are mapped on a coordinate plane, but the centroid and the feature vector may be mapped on a 3-dimensional (3D) Euclid space.

According to an embodiment, the pre-collected data may be data used only during a process of forming a cluster (or a centroid), and the newly collected data may be data used to configure training data or evaluating data. According to an embodiment, the newly collected data may be image data collected from a monocular camera and may be used to train or evaluate an AI model for monocular camera depth information estimation.

According to an embodiment, the data processing apparatus may sample the training data or evaluating data, based on the clusters formed through the clustering process described above. A specific cluster may include a relatively large amount of data compared to another cluster, and in this case, sampling of training or evaluating data by randomly extracting the same from whole data may disable the AI model to learn various features and performance of the AI model to be evaluated for various features. Thus, according to an embodiment, the same number of data may be randomly extracted and sampled from each cluster. According to an embodiment, a weight may be assigned to a cluster determined to be a vulnerable part, and different numbers of pieces of data may be randomly extracted and sampled from clusters according to weights.

The data processing apparatus may configure the training data or evaluating data, and train or evaluate the AI model, through processes according to various embodiments described above.

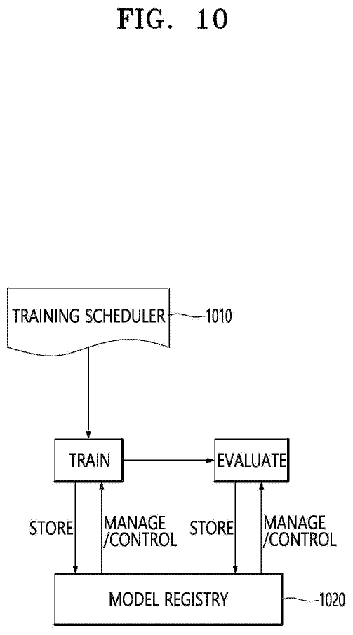

FIG. 10 is a diagram for briefly describing a training or evaluating process of an AI model, according to an embodiment.

Referring to FIG. 10, a process of configuring training data and training an AI model may be controlled by a training scheduler 1010 that may be included in a data processing apparatus. The training scheduler 1010 may be designed to control all training data configuring and AI model training processes. The training scheduler 1010 may initiate training data configuration and AI model training according to any appropriate method or condition. For example, the training scheduler 1010 may be designed to initiate the training data configuration and AI model training according to a certain cycle. As another example, the training scheduler 1010 may be designed to initiate training data configuration and AI model training when a small capacity or a small amount of data is accumulated in a database.

According to an embodiment, the data processing apparatus may perform evaluation on the AI model on which a training process has been performed. The data processing apparatus may configure evaluating data for evaluating the AI model through processes according to various embodiments described above, and evaluate the AI model, based on the configured evaluating data.

According to an embodiment, the evaluating data may be configured only by data that has not been configured as the training data among pieces of data included in the database. The processes of configuring the evaluating data and evaluating the AI model may be initiated by any one of various methods. For example, the processes of configuring the evaluating data and evaluating the AI model may be designed to be initiated in response to training of the AI model being ended. As another example, the processes of configuring the evaluating data and evaluating the AI model may be designed to be initiated in response to the training of the AI model being performed a certain number of times. As another example, the processes of configuring the evaluating data and evaluating the AI model may be designed to be initiated in response to the trained AI model being updated in a model registry (described in detail below).

According to an embodiment, the model registry that may store and manage data related to the training of the AI model may be configured.

Referring to FIG. 10, the model registry 1020 may be configured to store or manage the data related to the training or evaluating of the AI model or to control the training or evaluating of the AI model.

According to an embodiment, the data processing apparatus may store, in the model registry 1020, data related to the trained AI model, in response to the training of the AI model being initiated or ended. For example, a model obtained as a result of training, in particular, a parameter of the AI model, which is determined through training, may be stored in the model registry 1020. For example, a hyperparameter set before the training of the AI model may be stored. For example, various metrics of a training progress state of the AI model, for example, a loss and accuracy, may be stored.

According to an embodiment, the model registry 1020 may be configured to initiate additional training on the trained AI model or to manage distribution of the trained AI model.

According to an embodiment, the model registry 1020 may be configured to store and manage the evaluating data of the AI model. According to an embodiment, an evaluation index of the AI model may be stored in the model registry 1020, in response to the evaluating of the AI model being ended.

According to an embodiment, the model registry 1020 may be configured to store the evaluation index for each cluster such that a vulnerable part may be determined through clustering-based evaluation on the AI model. In detail, according to an embodiment, the data processing apparatus may extract feature vectors of image data, cluster the feature vectors into one or more clusters, and configure the evaluating data by sampling the same from the one or more clusters. Accordingly, the data processing apparatus may perform clustering-based AI model evaluation. According to an embodiment, the data processing apparatus may evaluate performance of the AI model for each cluster and calculate the evaluation index indicating a result of the evaluating, according to clusters. According to an embodiment, the model registry 1020 may be configured to store the evaluation index calculated by the data processing apparatus according to clusters.

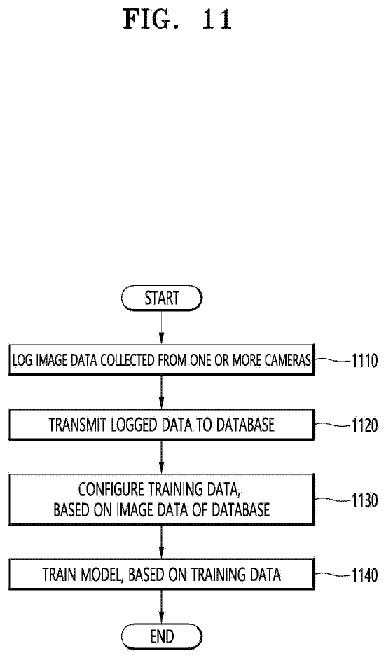

FIG. 11 is a flowchart of a data processing method for training a depth information estimation model, according to an embodiment.

The data processing method for training of the depth information estimation model, shown in FIG. 11, is related to the embodiments described above, and thus details described above may be applied to the data processing method of FIG. 11 even if omitted.

Operations shown in FIG. 11 may be performed by the autonomous driving apparatus or data processing apparatus described above. Specifically, the operations shown in FIG. 11 may be performed by a processor included in the autonomous driving apparatus or data processing apparatus described above.

In operation 1110, image data collected from one or more cameras may be logged.

According to an embodiment, each piece of the image data collected from the one or more cameras may include a plurality of images.

According to an embodiment, the plurality of images included in each piece of the image data collected from the one or more cameras may each include a timestamp indicating which indicates time information corresponding image is collected.

According to an embodiment, operation 1110 may include pairing up and storing images having a same timestamp.

According to an embodiment, the image data collected from the one or more cameras may be transmitted, to a display device, in image units having a same timestamp, to be displayed to a user.

According to an embodiment, operation 1110 may include storing each piece of the image data collected from the one or more cameras, in combination with inertia information measured by an IMU.

In operation 1120, the logged data may be transmitted to a database.

In operation 1130, training data may be configured based on the image data of the database.

According to an embodiment, operation 1130 may include acquiring a stereo rectification matrix, applying the acquired rectification matrix on the image data of the database, and verifying vertical disparity, based on a result of applying the rectification matrix.

According to an embodiment, the verifying of the vertical disparity may include calculating a numerical value of the vertical disparity by comparing the image data with data after the rectification matrix is applied, and acquiring the stereo rectification matrix again in response to the numerical value of the vertical disparity being greater than a threshold value.

According to an embodiment, operation 1130 may include extracting feature vectors of the image data of the database, clustering the feature vectors into one or more clusters, and sampling training data from the one or more clusters.

According to an embodiment, the clustering may include forming one or more base clusters, based on advance feature vectors extracted based on pre-collected data, extracting a centroid for each base cluster, based on the one or more base clusters, mapping the centroid for each base cluster on a coordinate plane, mapping the feature vector on the coordinate plane, calculating a distance between the feature vector and the centroid for each base cluster, and clustering the feature vector to a cluster closest to the centroid.

According to an embodiment, the sampling of the training data may include randomly extracting a same number of pieces of data from the one or more clusters.

In operation 1140, a model may be trained based on the training data.

According to an embodiment, the data processing method may further include configuring evaluating data, based on the image data of the database.

According to an embodiment, the data processing method may further include evaluating the model, based on the evaluating data.

According to an embodiment, the configuring of the evaluating data and the evaluating of the model may be performed in response to the trained model being updated in a model registry.

According to an embodiment, the evaluating of the model may include calculating an evaluation index.

According to an embodiment, the data processing method may further include storing the evaluation index in the model registry.

According to an embodiment, the configuring of the evaluating data may include extracting the feature vectors of the image data of the database, clustering the feature vectors into one or more clusters, and sampling the evaluating data from the one or more clusters, and the evaluating of the model may include calculating the evaluation index according to the one or more clusters.

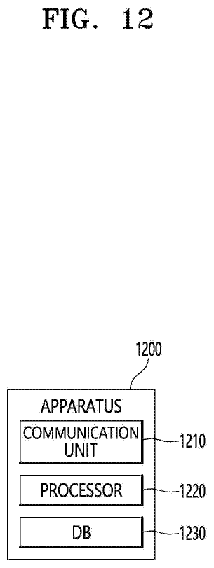

FIG. 12 is a block diagram of a data processing apparatus for training a depth information estimation model, according to an embodiment.

Referring to FIG. 12, the data processing apparatus for training the depth information estimation model 1200 may include a communication unit 1210, a processor 1220, and a database (DB) 1230. The data processing apparatus for training the depth information estimation model 1200 of FIG. 12 illustrate only components related to an embodiment. Thus, it would be obvious to one of ordinary skill in the art that the data processing apparatus for training the depth information estimation model 1200 may further include general-purpose components other than the components shown in FIG. 12.

The communication unit 1210 may include one or more components enabling wired/wireless communication with an external server or an external device. For example, the communication unit 1210 may include a short-range wireless communication unit (not shown), a mobile communication unit (not shown), and a broadcast receiver (not shown).

The DB 1230 is hardware storing various types of data processed by the data processing apparatus for training the depth information estimation model 1200, and may store programs for processing and control by the processor 1220. The DB 1230 may store payment information, user information, and the like.

The DB 1230 may include a random access memory (RAM) such as a dynamic random access memory (DRAM) or a static random access memory (SRAM), a read-only memory (ROM), an electrically erasable programmable read-only memory (EEPROM), CD-ROM, Blu-ray or another optical disk storage, a hard disk drive (HDD), a solid state drive (SSD), or a flash memory.

The processor 1220 controls all operations of the data processing apparatus for training the depth information estimation model. For example, the processor 1220 may execute programs stored in the DB 1230 to control an input unit (not shown), a display (not shown), the communication unit 1210, and the DB 1230, in general. The processor 1220 may execute the programs stored in the DB 1230 to control operations of the data processing apparatus for training the depth information estimation model 1200.

The processor 1220 may control at least some of the operations of the data processing apparatus for training the depth information estimation model 1200, described above with reference to FIGS. 1 through 11.

The processor 1220 may be realized by using at least one of an application-specific integrated circuit (ASIC), a digital signal processor (DSP), a digital signal processing device (DSPD), a programmable logic device (PLD), a field programmable gate array (FPGA), a controller, a micro-controller, a microprocessor, and electric units for performing other functions.

According to an embodiment, the data processing apparatus for training the depth information estimation model 1200 may be an electronic device having mobility. For example, the data processing apparatus for training the depth information estimation model 1200 may be implemented as a smart phone, a tablet personal computer (PC), a PC, a smart television (TV), personal digital assistant (PDA), a laptop computer, a media player, a navigation device, a device with a camera, or another mobile electronic device. Alternatively, the data processing apparatus for training the depth information estimation model 1200 may be implemented as a wearable device including a communication function and a data processing function, such as a watch, glasses, a hairband, or a ring.

According to another embodiment, the data processing apparatus for training the depth information estimation model 1200 may be an electronic device embedded in a vehicle. For example, the data processing apparatus for training the depth information estimation model 1200 may be an electronic device inserted into a vehicle for turning after production.

According to another embodiment, the data processing apparatus for training the depth information estimation model 1200 may be a server located outside a vehicle. The server may be implemented as a computer device or a plurality of computer devices, which provide a command, code, file, content, and service by communicating through a network. The server may receive data required to determine a moving route of the vehicle from devices mounted on the vehicle, and determine the moving route of the vehicle, based on the received data.

According to another embodiment, processes performed by the data processing apparatus for training the depth information estimation model 1200 may be performed by at least some of the electronic device having mobility, the electronic device embedded in a vehicle, and the server located outside a vehicle.

According to an embodiment of the present disclosure, training data or evaluating data may be configured so as to effectively train an artificial intelligence model performing functions including depth information estimation.

In addition, image data collected through a camera, data related to the trained artificial intelligence model, and evaluation result data of the artificial intelligence model may be effectively inquired into and managed, and accordingly, a process of training the artificial intelligence model may be continuously improved henceforth.

The embodiments according to the present disclosure may be implemented in a form of a computer program executable by various components on a computer, and such a computer program may be recorded in a computer-readable medium. Here, the computer-readable medium may include hardware devices specially designed to store and execute program instructions, such as magnetic media, such as a hard disk, a floppy disk, and a magnetic tape, optical recording media, such as CD-ROM and DVD, magneto-optical media such as a floptical disk, and read-only memory (ROM), random-access memory (RAM), and a flash memory.

The computer program may be specially designed for the present disclosure or well known to one of ordinary skill in the computer software field. Examples of the computer program include not only machine codes generated by a compiler, but also high-level language codes executable by a computer by using an interpreter or the like.

According to an embodiment, a method according to various embodiments of the present disclosure may be provided by being included in a computer program product. The computer program products are products that can be traded between sellers and buyers. The computer program product may be distributed in a form of machine-readable storage medium (for example, a compact disc read-only memory (CD-ROM)), or distributed through an application store (for example, Play Store™) or directly or online between two user devices (for example, download or upload). In the case of online distribution, at least a part of the computer program product may be at least temporarily stored or temporarily generated in the machine-readable storage medium such as a server of a manufacturer, a server of an application store, or a memory of a relay server.

Unless an order is clearly stated or unless otherwise stated, operations configuring a method according to the present disclosure may be performed in an appropriate order. the present disclosure is not necessarily limited by an order the operations are described. In the present disclosure, the use of all examples or exemplary terms (for example, “etc.”) is merely for describing the present disclosure in detail and the scope of the present disclosure is not limited by those examples or exemplary terms unless defined in the claims. Also, it would be obvious to one of ordinary skill in the art that various modifications, combinations, and changes may be configured according to design conditions and factors within the scope of claims or equivalents.

Therefore, the scope of the present disclosure should not be determined limitedly based on the above-described embodiments, and not only the appended claims but also all ranges equivalent to or equivalently changed from the claims are within the scope of the present disclosure.

What is claimed is:

1. A data processing method for training a depth information estimation model, comprising:
logging image data collected from one or more cameras;
transmitting the logged image data to a database;
configuring training data, based on the image data of the database; and
training a model, based on the training data.

2. The data processing method of claim 1, wherein each piece of the image data collected from the one or more cameras comprises a plurality of images,
wherein each of the plurality of images comprises a timestamp which indicates time information corresponding image is collected, and
the logging of the image data comprises pairing and storing images having a same timestamp.

3. The data processing method of claim 1, wherein the logging of the image data comprises storing each piece of the image data collected from the one or more cameras, in combination with inertia information measured by an inertial measurement unit.

4. The data processing method of claim 2, further comprising transmitting, to a display device, the image data collected from the one or more cameras in image units having the same timestamp, to display the image data collected from one or more cameras to a user.

5. The data processing method of claim 1, wherein the configuring of the training data comprises:
acquiring a stereo rectification matrix;
applying a rectification matrix to the image data of the database; and
verifying a vertical disparity, based on a result of applying the rectification matrix.

6. The data processing method of claim 1, wherein the configuring of the training data comprises:
extracting a feature vector for the image data of the database;
clustering the feature vector as one or more clusters; and
sampling the training data from the one or more clusters.

7. The data processing method of claim 1, further comprising:
configuring evaluating data, based on the image data of the database; and
evaluating the model, based on the evaluating data.

8. The data processing method of claim 7, wherein the evaluating of the model comprises calculating an evaluation index, and
the data processing method further comprises storing the evaluation index in a model registry.

9. A data processing apparatus for training a depth information estimation model, comprising:
a memory storing at least one program; and
a processor configured to execute the at least one program to:
log image data collected from one or more cameras;
transmit the logged image data to a database;
configure training data, based on the image data of the database; and
train a model, based on the training data.

10. A computer-readable recording medium having recorded thereon a program for executing the data processing method of claim 1 on a computer.
